(19) United States
(12) Patent Application Publication
(10) Pub. No.: US 2015/0158465 A1
(43) Pub. Date: Jun. 11, 2015

(54) Support Winch

(71) Applicant: SAF-HOLLAND GmbH, Bessenbach (DE)

(72) Inventor: Reinhold Riedl, Miltenberg (DE)

(21) Appl. No.: 14/561,974

(22) Filed: Dec. 5, 2014

(30) Foreign Application Priority Data
Dec. 6, 2013 (DE) 10 2013 225 180.7

(51) Int. Cl. B60S 9/16

(52) U.S. Cl. CPC B60S 9/16

(57) ABSTRACT

The invention relates to a support winch, in particular for trailers of utility vehicles, comprising a support unit extending along a vertical axis, wherein the support unit comprises an upper part and a lower part, and wherein the upper part and the lower part each have a longitudinal axis, wherein an angle between the longitudinal axes can be adjusted.

### BACKGROUND OF THE INVENTION

The present invention relates to a support winch, in particular for trailers of utility vehicles or commercial vehicles, as well as to a support foot, in particular for support winches.

Support winches of the type in question are usually arranged in pairs at the front of semi-trailers, for example. They can be extended or retracted, i.e. brought into a support position or a transport position, wherein they are also used in order to lift the front area of the semi-trailer should this become necessary during hitching. Parked semi-trailers can be lowered at the rear when their air bellows or their tires lose air. Due to the geometry, a lower area of the support winches, which are vertically and rigidly fixed to the frame of the semi-trailer, inclines forwards, i.e. in the direction of travel. However, the load-bearing support foots of the support winches, which usually firmly and frictionally engaged contact the ground, prevent such a translatory motion. As a consequence, great stresses build up in the support winches. Possibly, the support winches may even bend such that it is no longer possible to retract the support winches.

Therefore, the object underlying the present invention is to provide a support winch, in particular for trailers of utility vehicles, as well as a support foot, in particular for support winches, which will not bend when the rear of a trailer is lowered.

### SUMMARY OF THE INVENTION

According to the invention, a support winch, in particular for trailers of utility vehicles, comprises a support unit extending along a vertical axis, wherein the support unit comprises an upper part and a lower part, and wherein the upper part and the lower part each have a longitudinal axis, wherein an angle between the longitudinal axes can be adjusted. As a matter of course, the use of the support winch or of such support winches is not limited to the field of utility vehicles, but they can also be used of in the field of passenger cars or in agriculture, etc. Expediently, the adjustment of the angle between the upper part and the lower part makes it possible that the upper part and the lower part can bend or kink relative to each other or that the lower part can bend relative to the upper part. Advantageously, bending or adjusting the angle is done along a direction of travel of the trailer. As a matter of course, bending or adjusting the angle can also be possible contrary to or transverse to or in other directions than the direction of travel. It is decisive that the support winch is adapted to allow for an adjustment of the angle between the upper part and the lower part. If the upper part and the lower part are aligned exactly flush, the angle is 0° or about 0°. The two longitudinal axes are then flush and are oriented parallel to the vertical axis. Expediently, however, the angle can be increased to values of more than 0° in order to compensate or balance a movement of the trailer or in general of a body to be supported in relation to the road surface underground. Usually, the movement of the trailer is caused by lowering the rear area thereof, by reducing the air pressure in the wheels or in the air bellows of the air suspension, for example. Thus, a front part of the trailer supported by one or more support winches lifts, wherein mainly a very rapid coupling or decoupling to a tractor vehicle is made possible. The support unit usually comprises an area, in which it is in contact to the ground or to the road surface underground. When the trailer is supported by the support winch(es), this area represents a fixed point so to speak, which is stationary and cannot be moved. Advantageously, by bending the support winch a movement of the trailer in relation to said fixed point can be permitted, such that relative movements of the trailer to the fixed point can be compensated, which can occur when the rear part of the trailer is lowered, for example. All forces resulting from said relative movement advantageously can be kept away from the support winch by adjusting the angle between the upper part and the lower part. Thus, it is not only possible to avoid damage, but the support winch can also be designed more light-weight, i.e. in particular using less material, which is beneficial to the available load capacity and the costs. As has been mentioned above, such support winches are usually used in pairs. As a matter of course, it may also be sufficient to use only one support winch, when the trailer is appropriately light-weight, for example.

Preferably, the support unit is an inner support pipe of the support winch, which pipe is movable within an outer support pipe along the vertical axis in order to adjust the height of the support winch. The vertical axis extends essentially transverse to the direction of travel. The longitudinal axis of the upper part expediently lies flush with the vertical axis. This means that the angle between the longitudinal axis of the lower part and the upper part corresponds to an angle between the longitudinal axis of the lower part and the vertical axis. The cross-sections of the inner support pipe and of the outer support pipe are preferably quadrangular, particularly preferably square. As matter of course, also round, particularly preferably also approximately circular cross-sections are possible. Advantageously, the inner support pipe is guided linearly along the vertical axis by the outer support pipe, wherein no rotation of the inner support pipe about the vertical is permitted. The height is preferably adjusted by means of a spindle drive arranged within the support winch, wherein the spindle drive comprises a spindle and a spindle nut, and wherein the spindle nut is connected to the inner support pipe. By rotating the spindle, by means of a hand crank arranged on the support winch, for example, the spindle nut and the inner support pipe connected to the spindle can be moved relative to the outer support pipe, such that a height or a support height of the support winch may be set. Advantageously, the inner support pipe comprises the upper part and the lower part, i.e., to put it differently, it is designed two-piece. The inner support pipe can fully or partially be inserted into the outer support pipe. As a matter of course, at the latest when also the lower part is arranged within the outer support pipe, the angle between the longitudinal axis of the upper part and the longitudinal axis of the lower part has to be 0° or about 0°. As a matter of course, also the outer support pipe may form the upper part and the lower part. However, this solution may possibly be constructionally more complex since in this case collisions with the spindle may occur more readily when the angle between the longitudinal axes of the upper part and of the lower part is adjusted. In this connection, it should be noted that in case the support unit forms the inner support pipe, a lower end of the spindle ends advantageously above a lower end of the outer support pipe. Only when a swivel joint or a joint or abutment between the upper part and the lower part lies outside the outer support pipe, does it become possible to adjust the angle between the longitudinal axes. Thus, when it is ensured that the spindle ends still above the lower end of the outer support pipe, it is very easily ensured constructionally that, when the angle is adjusted, the spindle will not be damaged by the lower part, for example.

Expediently, the upper part and the lower part are connected by a swivel joint comprising an articulated axle, wherein the articulated axle preferably extends essentially transverse to the vertical axis. Advantageously, the articulated axle also extends transverse to the direction of travel. For cost reasons, the swivel joint is preferably designed as a sliding contact bearing. As a matter of course, also a rolling contact bearing may be provided. The swivel joint allows to adjust the angle between the respective longitudinal axes of the upper part and of the lower part, wherein the articulated axle represents the fulcrum. Preferably, the swivel joint is designed such that it permits exclusively to adjust the angle along (or contrary to) the direction of travel and has no other degrees of freedom, such as transverse to the direction of travel. As a matter of course, also two or more swivel joints may be provided. There may also be provided a swivel joint allowing for an adjustment of the angle in the direction of travel, while another swivel joint allows for an adjustment of the angle contrary to the direction of travel.

Expediently, the support unit comprises a centerline extending parallel to the vertical axis and intersecting a cross-section of the support unit essentially centrally, wherein the articulated axle is arranged along a direction of travel displaced in relation to the centerline. Advantageously, the articulated axle is arranged contrary to the direction of travel displaced in relation to the centerline. Thus, both on the upper part and on the lower part, space is provided for respective contact surfaces, which will be described in more detail below. In addition, the force flow from the upper part to the lower part and vice versa during such a positioning of the articulated axle can be optimized. However, in particular, said arrangement allows for a smooth adjustment of the angle between the longitudinal axis of the upper part and the longitudinal axis of the lower part. As a matter of course, also embodiments may be provided, wherein the articulated axle is arranged in the direction of travel displaced in relation to the centerline. Also an approximately central arrangement is conceivable, which is preferred in particular when the support winch is to allow bending in and contrary to the direction of travel.

Expediently, the support unit comprises at least one support foot, by means of which a contact to a road surface or the like can be made, wherein the support foot is connected to the lower part rigidly or by means of a joint. The support foot represents the above-mentioned “fixed point”. Advantageously, thus, the support foot is rigidly or by means of a joint connected to the support unit, in particular to the lower part. The support foot advantageously can be designed as a simple load-bearing plate, which preferably has a downwards facing curvature, which allows for unrolling on the road surface plane. In the present case, however, the support unit makes it possible to do without a complexly designed support foot, as it is in some cases known in the prior art. However, as a matter of course, the support foot may also be designed as a swivel foot, i.e. such that it can be connected to the support unit or to the lower part, respectively, by means of a joint. In this case, the support foot in turn allows for adjusting the angle or bending in relation to the support unit or in particular in relation to the lower part.

Advantageously, a fulcrum of the joint of the support foot is arranged along the direction of travel displaced in relation to the centerline. In a particularly preferred embodiment, the joint is arranged in the direction of travel displaced in relation to the centerline. This may be beneficial both for the force flow in the support winch and for the adjustment of the angle between the longitudinal axis of the upper part and the longitudinal axis of the lower part or for a swiveling operation of the lower part, respectively. Advantageously, the joint is also a ball joint so that the support foot advantageously is designed as a ball foot, which can adapt to the road surface underground in all directions.

Expediently, the articulated axle of the joint is arranged contrary to the direction of travel, and the fulcrum of the joint is arranged in the direction of travel displaced in relation to the centerline. As has already been indicated, such a configuration allows for the best possible force flow as well as an easy bending of the support unit. In particular, the below-described contact surfaces of the support unit can be ideally positioned.

Preferably, the upper part and the lower part have contact surfaces corresponding to each other, which allow for a force transmission of the support unit along the vertical axis in that they may be brought into a form fit and/or a force fit with each other. Advantageously, the upper part and the lower part support each other via the contact surfaces when the upper part and the lower part lie flush, when the angle between the longitudinal axes is 0° or about 0°. As a matter of course, the contact surfaces may take the most different shapes. For example, the contact surfaces may also comprise projections and/or recesses or engagement regions, which can be made to engage into each other. Basically, the contact surface(s) can take up the entire cross-section of the upper part or of the lower part, but they can also form only a part of the cross-section. Advantageously, at least one of the contact surfaces is at least in certain sections provided with a wear-protection layer in order to protect the contact surfaces. Here, as a matter of course, the contact surfaces need not necessarily be formed by the upper part or the lower part themselves. They may be separate components, which can also be designed such that they can be replaced in case they are worn, for example. The contact surfaces can be adapted both for a line contact and for a surface contact. In addition, the contact surfaces can also be designed as engagement regions corresponding to each other, which engage into each other and, thus, build up an additional stability or strength radially to the vertical axis. Advantageously, the contact surfaces also comprise sliding surfaces, which slide one above the other during bending and, thus, ensure a maximum stability of the support winch during bending. Such sliding areas can also fulfill the function of a protective element since they can cover or prevent a gap between the upper part and the lower part.

Advantageously, the support unit also comprises a protective element covering a gap forming between the upper part and of the lower part or between the respective contact surfaces when the angle between the longitudinal axes of the upper part and of the lower part is adjusted. The protective element acts like a kind of curtain, which is to prevent that somebody by accident gets caught in said gap, which might lead to injury when the gap closes. Advantageously, the protective element can be designed as a kind of protective cover or protective sleeve covering an area of the support unit, where a gap may form. As a matter of course, the protective element has a suitable bending stiffness or variability in order to allow for an adjustment of the angle. Advantageously, the protective element at least in certain sections is designed both variable in length and sufficiently flexible. Apart from the above-mentioned function of the protective element, its use also has the advantage to offer that the contact surfaces are protected from outer influences such as dirt and moisture. It should be noted that the protective element is designed such that the support unit, i.e. in particular the inner support pipe, can still be retracted into the outer support pipe at least partially.

Expediently, the support winch, in particular the inner support pipe, comprises at least one abutment mechanism adapted to limit a maximum value of the angle, wherein the abutment mechanism preferably comprises a limit stop and a supporting surface. The bending is thus suppressed in that moment when the limit stop contacts or hits the supporting surface and rests against said supporting surface. Advantageously, the abutment mechanism is arranged in the area of the swivel joint. Expediently, the limit stop is fixed to the upper part, and the supporting surface is fixed to the lower part, or vice versa. Thus, the limit stop and the supporting surface advantageously are arranged on different parts of the support unit. Depending on the available space, the abutment mechanism can be arranged both within and outside the support unit. Advantageously, also the limit stop is adjustable in length, or the supporting surface is variable in its position such that the maximum possible angle can be varied. For example, the limit stop can be connected to the upper part or to the lower part via a suitable system of bores by means of a simple splint connection such that the length can be easily adjusted. Likewise, the supporting surface can be form-fittingly and/or force-fittingly connected to the upper part or to the lower part, in particular by means of screws/bolts, such that the height or position thereof can be varied. This holds true both in case the abutment mechanism is arranged within the support unit and when the abutment mechanism is arranged outside the support unit. As a matter of course, the accessibility is clearly greater when the abutment mechanism is arranged outside the support unit. It should, however, be noted that the retraction of the support unit or of the inner support pipe, respectively, into the outer support pipe is not unduly limited.

Expediently, the abutment mechanism is arranged within the support unit, wherein the limit stop is preferably fixed to an inside of the lower part and projects into the upper part so as to be able to rest against the supporting surface arranged at an inside of the upper part. The supporting surface can directly represent the inside of the upper part, but it can also be formed as an extra component, which form-fittingly and/or force-fittingly is connected to the inside of the upper part. As a matter of course, the above-mentioned variabilities with regard to the arrangement of the limit stop and of the supporting surface likewise apply to the embodiment described here. Preferably, also a variant is possible, wherein the embodiment, which has been just described, is exactly reversed. This means that the limit stop is fixed to an inside of the upper part and projects into the lower part in order to be able to rest against the supporting surface arranged on an inside of the lower part. In this context, it should be mentioned that also the contact surfaces in relation to each other act like an abutment mechanism or provide the effect thereof, however not for a maximum permissible angle between the longitudinal axes, but for an angle of 0° or about 0°.

Advantageously, the support winch comprises a resetting element adapted to align the upper part and the lower part essentially along the vertical axis. Here, “align” means that the angle between the longitudinal axes of the upper part and of the lower part is reduced to about 0°. Advantageously, the resetting element is formed by a spiral spring or a leave spring. Also conceivable are accordingly flexibly and elastically formed plastic materials or elastomers adapted to align the upper part and the lower part in relation to each other when the load on the support winch (along its vertical axis) has been removed. When the upper part and the lower part are aligned in relation to each other, they are form-fittingly and/or force-fittingly connected to each other via the contact surfaces.

Preferably, when the angle between the longitudinal axis of the upper part and the longitudinal axis of the lower part is adjusted, the resetting element builds up a tensile or a compressive force, which can align the upper part and the lower part along the vertical axis. This means that, advantageously, the resetting element during bending is either stretched or extended or upset or compressed or itself bent such that energy is stored in the resetting element, which energy, when the load on the support winch is released or removed, causes the upper part and the lower part to be re-aligned in relation to each other.

Advantageously, the resetting element is also fixed to the limit stop and can make use of the latter as a lever, so to speak, in order to pull closer or push away the respective opposite part or the respective other part of the support unit in order to re-align the support unit.

Expediently, the abutment mechanism limits the angle in a range of about 3° to 30°. Preferably, the angle is also in a range of about 5° to 25°, particularly preferably in a range of about 7° to 20°.

According to the invention, there is provided a support foot comprising a joint, wherein a fulcrum of the joint is arranged eccentrically. Expediently, the mentioned advantages and features of the support winch according to the invention can be applied to the support foot according to the invention and vice versa.

Further advantages and features become apparent from the following description of preferred embodiments of the support winch according to the invention with reference to the appended Figures. Individual features of the individual embodiments can be combined with each other within the scope of the invention.

### BRIEF DESCRIPTION OF THE DRAWINGS

The Figures show:

FIG. 1a shows a utility vehicle trailer with support winches in a bent position and in an unbent position;

FIG. 1b shows the utility vehicle trailer with support winches in a bent position;

FIG. 2a shows a sectional view of a preferred embodiment of a support winch;

FIG. 2b shows the preferred embodiment of FIG. 2a of a support winch, wherein an angle between the longitudinal axes of the upper part and of the lower part, respectively, has been adjusted in relation to FIG. 2a;

FIG. 3a shows a preferred embodiment of the support foot;

FIG. 3b shows a sectional view of the embodiment known from FIG. 3a of a support foot;

FIG. 4 shows a sketchy illustration of a preferred embodiment of a support winch with a resetting element in the form of a spiral spring and with a protective element;

FIG. 5 shows a preferred embodiment of a support winch with a locking mechanism arranged outside; and

FIG. 6 shows a schematic view of a contact surface with a sliding surface.

### DETAILED DESCRIPTION OF THE PREFERRED EMBODIMENTS

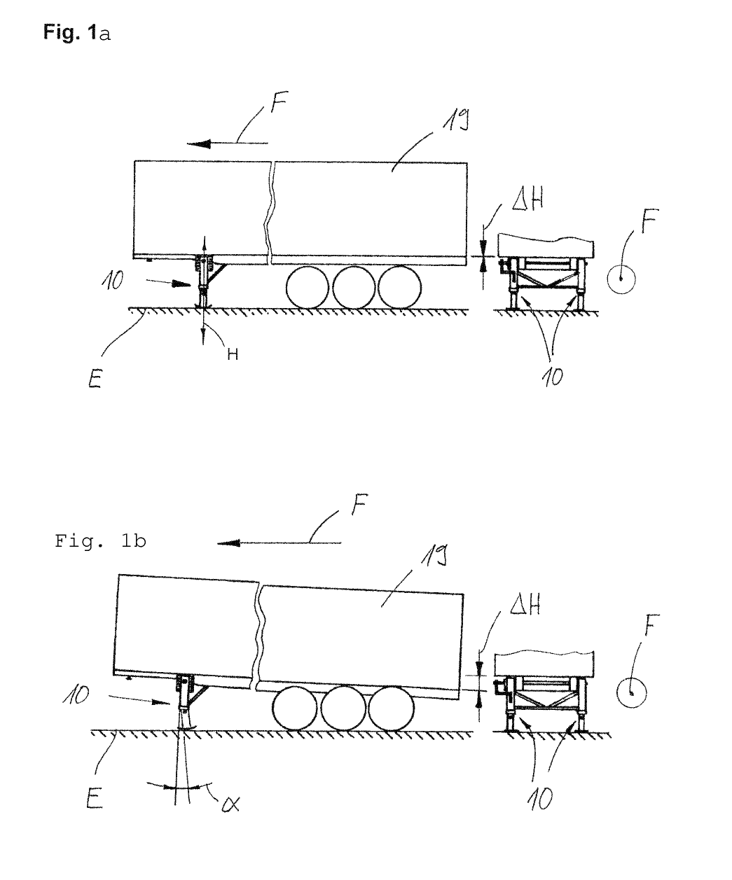

The upper half of FIG. 1a shows a side view and a front view of a trailer 19. A part or area of the trailer 19, which is at the front when seen in a direction of travel F, is supported by a pair of support winches 10, which essentially extend along a vertical axis H. The entire trailer 19 is aligned essentially parallel to a road surface plane E. In FIG. 1b, the utility vehicle trailer 19 is lowered in the rear area thereof, which can be done by means the tire pressure or by means of the air bellows. The resulting height difference ΔH between the front and the rear parts of the trailer 19 is clearly visible in the bottom half of the Figure. Here, the support winch 10 or the support winches 10 bend by an angle α.

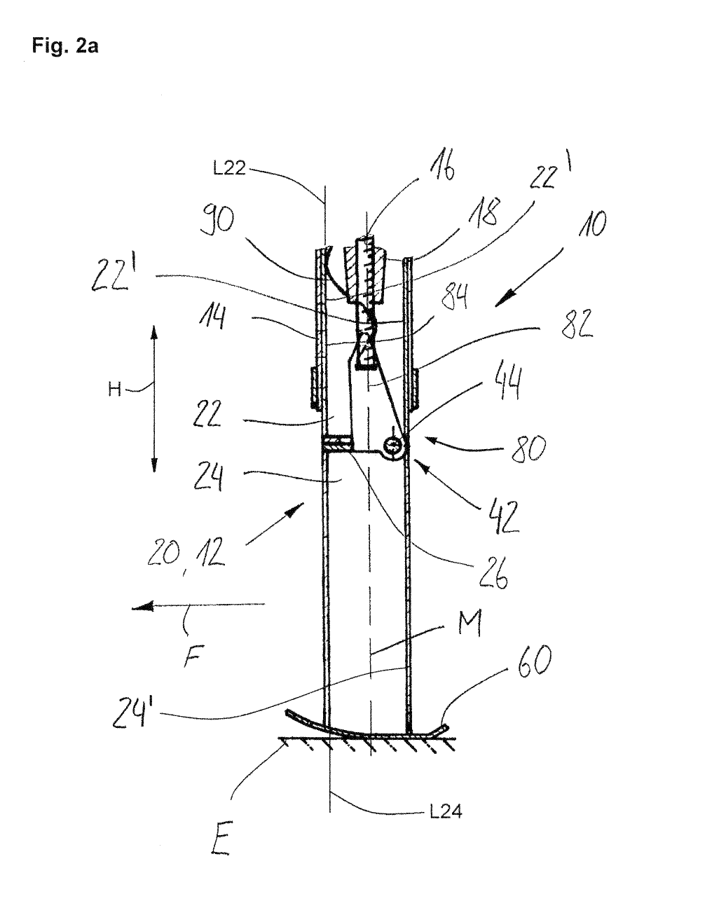

FIG. 2a shows a sectional view of a preferred embodiment of a support winch 10. The support winch 10 comprises a support unit 20 corresponding to an inner support pipe 12 of the support winch 10. The support unit 20 or the inner support pipe 12, respectively, is arranged within an outer support pipe 14. The support unit 20 comprises an upper part 22 and a lower part 24, wherein a support foot 60 is arranged on the lower part 24. The upper part 22 has a longitudinal axis L22, while the lower part 24 has a longitudinal axis L24. Both longitudinal axes L22 and L24 are flush and extend parallel to a vertical axis H. An angle (not shown here) between the longitudinal axes L22 and L24 is 0° or about 0°. Within the support winch 10 or the support unit 20 a spindle 16 with a spindle nut 18 is indicated, which is connected to the upper part 22 of the inner support pipe 12 (not shown here). The upper part 22 and the lower part 24 are connected by means of a swivel joint 42 comprising an articulated axle 44. In the area of the swivel joint 42 a limit stop 80 is arranged, which projects into the upper part 22. It is clearly visible that the articulated axle 44 is arranged contrary to a direction of travel F displaced in relation to a centerline M of the support winch 10. The limit stop 80 is connected to a resetting element 90 formed as a leave spring. At an inside 22′ of the upper part 22, there is provided a supporting surface 82.

FIG. 2b shows the embodiment known from FIG. 2a, wherein the longitudinal axis L22 of the upper part and the longitudinal axis L24 of the lower part 24 are positioned in relation to each other at an angle α, which is not 0°. In this position, the limit stop 80 rests against the supporting surface 82 in the upper part 22 of the support winch 10. In comparison to FIG. 2a it can be clearly seen that the resetting element 90 is tensioned. Advantageously, the shape of the support foot 60, which is curved towards the road surface plane E, allows for a slight unrolling of the entire support winch 10. It also becomes clear that a very simply constructed support foot 60 is sufficient, since a swivel joint 42 is provided.

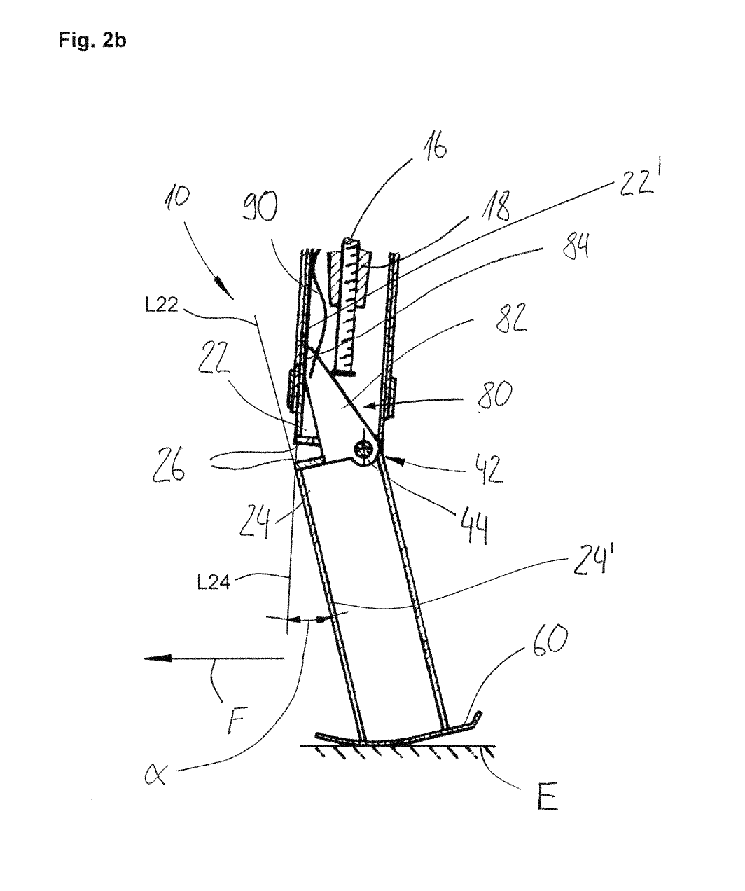

FIG. 3a shows a further preferred embodiment of a support foot 60, which by means of a joint 62 advantageously formed as a ball joint, is connected to a lower part 24 of a support unit 20 or a support winch 10, respectively (not completely shown here). A fulcrum 64 of the joint 62 is arranged in a direction of travel F displaced in relation to a centerline M of the support winch 10.

FIG. 3b shows a sectional view of the embodiment of the support foot 60 known from FIG. 3a. As a matter of course, the joint 62, which is formed as a ball joint, which allows for a movability along and transverse to a direction of travel F, can also be formed as a joint, which allows for bending only along the direction of travel F.

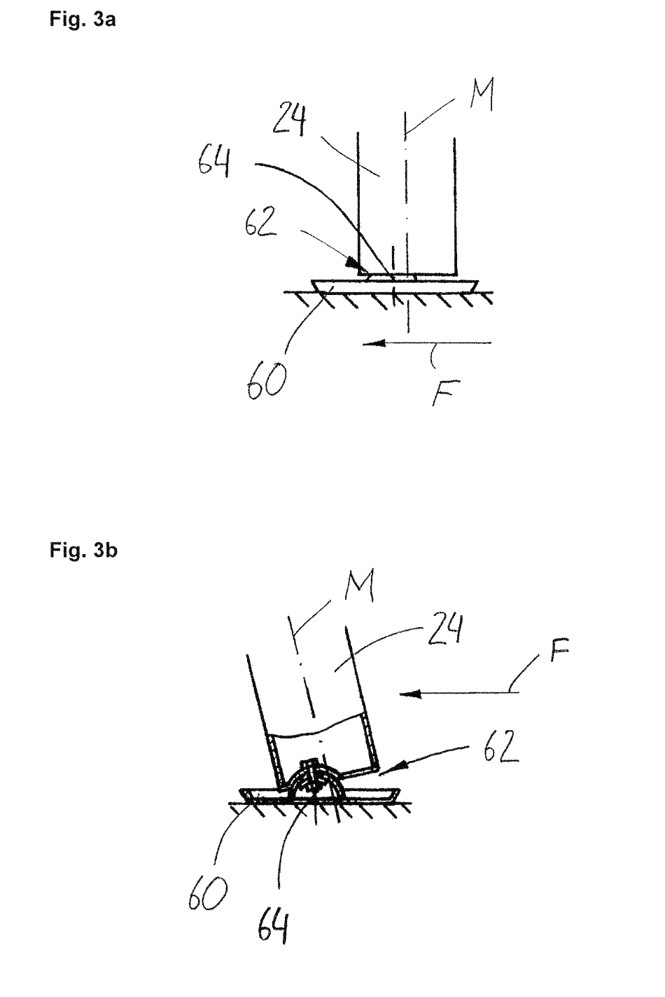

FIG. 4 shows a partial view of a preferred embodiment of a support unit 20 comprising an upper part 22 and a lower part 24 connected by means of a swivel joint 42. An articulated axle 44 represents the axis of rotation. A gap forming between the upper part 22 and the lower part 24 is covered by a protective element 92 such that access from the outside is prevented. Within the support unit 20, there is arranged a resetting element 90 formed as a spiral spring. The upper part 22 and the lower part 24 can support themselves via contact surfaces 26, which correspond to each other. The upper part 22 and the lower part 24 have longitudinal axes L22 and L24, respectively, which are positioned at an α relative to each other.

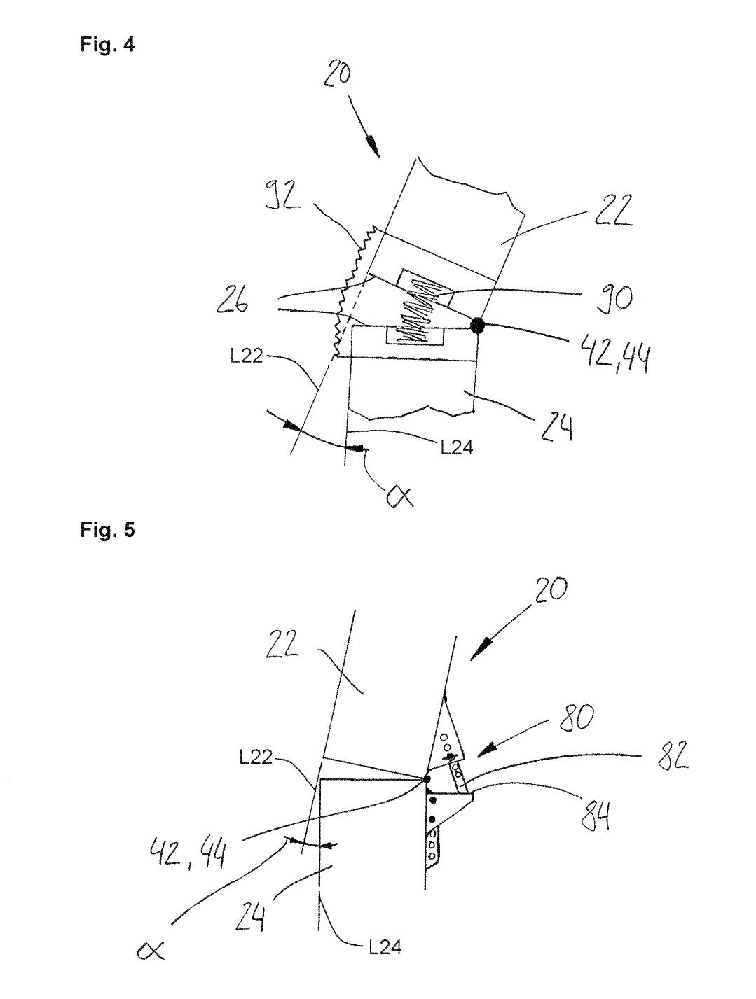

FIG. 5 shows a further preferred embodiment of a support unit 20 comprising an upper part 22 and a lower part 24. In a known manner, a longitudinal axis L22 of the upper part 22 and a longitudinal axis L24 of the lower part 24 are positioned at an angle α relative to each other. In the area of a swivel joint 42, which comprises an articulated axle 44, there is arranged outside the support unit 20 an abutment mechanism 80, comprising a limit stop 82 and a supporting surface 84. Both the supporting surface 84 and the limit stop 82 can be arranged variably in the upper part 22 or in the lower part 24 by means of respective connection elements (such as screws/bolts, pins or splints). Thus, an angle α can be adjusted to a maximum permissible value.

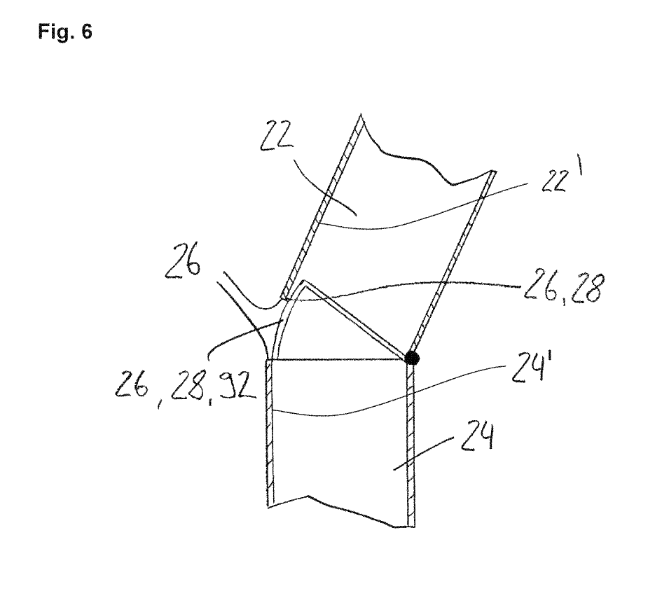

FIG. 6 shows a schematic view of two contact surfaces 26 comprising sliding surfaces 28. A lower part 24 comprises the contact surface 26, which is everted towards the top and which forms the sliding surface 28 and which simultaneously fulfills the function of a protective element 92 since due to this shape of the contact surface 26 no gap will form between the lower part 24 and an upper part 22 when the angle between the respective longitudinal axes is adjusted. A sliding surface 26 of the upper part 22, which is formed on the inside 22′ of the upper part 22, can slide downwards on the sliding surface 26 of the lower part 24 when the support unit bends. Moreover, as a matter of course, the contact surfaces 26 also fulfill the known supporting function, when the upper part 22 and the lower part 24 lie flush with each other.

### LIST OF REFERENCE SIGNS

10 support winch
12 inner support pipe
14 outer support pipe
16 spindle
18 spindle nut
19 trailer
20 support unit
22 upper part
22′ inside of the upper part
24 lower part
24′ inside of the lower part
26 contact surface
28 sliding surface
42 swivel joint
44 articulated axle
60 support foot
62 joint
64 fulcrum
80 abutment mechanism
82 limit stop
84 supporting surface
90 resetting element
92 protective element
F direction of travel
E road surface plane
ΔH height difference
M centerline
L22, L24 longitudinal axis
H vertical axis
α angle

The invention claimed is as follows:

1. A support winch for a vehicle comprising:
a support unit extending along a vertical axis;
wherein the support unit comprises an upper part and a lower part;
wherein the upper part and the lower part each have a longitudinal axis; and
wherein an angle between the longitudinal axes can be adjusted.

2. The support winch of claim 1, wherein the support unit comprises an inner support pipe of the support winch and wherein the inner support pipe is configured to be displaced within an outer support pipe along the vertical axis to adjust the height of the support winch.

3. The support winch of claim 2, wherein the upper part and the lower part are connected by a swivel joint comprising an articulated axle, and wherein the articulated axle extends substantially transverse to the vertical axis.

4. The support winch of claim 3, wherein the support unit comprises a centerline extending parallel to the vertical axis and intersecting a cross-section of the support unit substantially centrally, and wherein the articulated axle is arranged along a direction of travel displaced in relation to the centerline.

5. The support winch of claim 4, wherein the support unit comprises at least one support foot configured to contact a road surface; and wherein the support foot is one of rigidly connected to the lower part and connected to the lower part by a joint.

6. The support winch of claim 5, wherein a fulcrum of the joint of the support foot is arranged along the direction of travel displaced in relation to the centerline.

7. The support winch of claim 6, wherein the articulated axle of the swivel joint is arranged contrary to the direction of travel and the fulcrum of the joint is arranged in the direction of travel displaced in relation to the centerline.

8. The support winch of claim 7, wherein the upper part and the lower part comprise contact surfaces corresponding to each other, and that are at least one of form fit and free fit with each other, which allow for a force transmission of the support unit along the vertical axis.

9. The support winch of claim 8, wherein the support winch comprises at least one abutment mechanism adapted to limit a maximum value of the angle, and wherein the abutment mechanism preferably comprises a limit stop and a supporting surface.

10. The support winch of claim 9, wherein the abutment mechanism is arranged within the support unit, and wherein the limit stop preferably is fixed to an inside of the lower part and projects into the upper part to rest against the supporting surface arranged at an inside of the upper part.

11. The support winch of claim 10, wherein the support winch comprises at least one resetting element configured to align the upper part and the lower part substantially along the vertical axis.

12. The support winch of claim 11, wherein when the angle is adjusted, the resetting element generates a one of a tensile force and a compressive force to align the upper part and the lower part along the vertical axis.

13. The support winch of claim 12, wherein the abutment mechanism limits the angle in a range of about 3° to about 30°.

14. The support winch of claim 1, wherein the upper part and the lower part are connected by a swivel joint comprising an articulated axle, and wherein the articulated axle extends substantially transverse to the vertical axis.

15. The support winch of claim 14, wherein the support unit comprises a centerline extending parallel to the vertical axis and intersecting a cross-section of the support unit substantially centrally, and wherein the articulated axle is arranged along a direction of travel displaced in relation to the centerline.

16. The support winch of claim 1, wherein the support unit comprises at least one support foot configured to contact a road surface; and wherein the support foot is one of rigidly connected to the lower part and connected to the lower part by a joint.

17. The support winch of claim 16, wherein a fulcrum of the joint of the support foot is arranged along the direction of travel displaced in relation to the centerline.

18. The support winch of claim 14, wherein the articulated axle of the swivel joint is arranged contrary to the direction of travel, and the fulcrum of the joint is arranged in the direction of travel displaced in relation to the centerline.

19. The support winch of claim 1, wherein the upper part and the lower part comprise contact surfaces corresponding to each other, and that are at least one of form fit and free fit with each other, which allow for a force transmission of the support unit along the vertical axis.

20. The support winch of claim 1, wherein the support winch comprises at least one abutment mechanism adapted to limit a maximum value of the angle, and wherein the abutment mechanism preferably comprises a limit stop and a supporting surface.

21. The support winch of claim 20, wherein the abutment mechanism is arranged within the support unit, and wherein the limit stop preferably is fixed to an inside of the lower part and projects into the upper part to rest against the supporting surface arranged at an inside of the upper part.

22. The support winch of claim 1, wherein the support winch comprises at least one resetting element configured to align the upper part and the lower part substantially along the vertical axis.

23. The support winch of claim 22, wherein when the angle is adjusted, the resetting element generates a one of a tensile force and a compressive force to align the upper part and the lower part along the vertical axis.

24. The support winch of claim 1, wherein the abutment mechanism limits the angle in a range of about 3° to about 30°.

25. A support winch for a vehicle, comprising:
a support pipe having a longitudinal axis and a centerline;
a support foot configured to contact a road surface; and
a joint operably coupling the support foot to the support pipe, the joint having a fulcrum that is arranged eccentrically with respect to the centerline of the support pipe.
